(19) United States
(12) Patent Application Publication
(10) Pub. No.: US 2019/0326782 A1
(43) Pub. Date: Oct. 24, 2019

(54) Wireless Charging System With Metallic Object Detection

(71) Applicant: Apple Inc., Cupertino, CA (US)

(72) Inventors: Christopher S. Graham, San Francisco, CA (US); Matthew G. Czapar, San Francisco, CA (US)

(21) Appl. No.: 16/031,858

(22) Filed: Jul. 10, 2018

Related U.S. Application Data
(60) Provisional application No. 62/661,966, filed on Apr. 24, 2018.

(51) Int. Cl. H02J 50/12; H02J 50/05; H02J 7/02; H01F 27/28; H02J 50/60

(52) U.S. Cl. CPC H02J 50/12; H02J 50/05; H02J 50/60; H01F 27/28; H02J 7/025

(57) ABSTRACT

A wireless power transmission system has a wireless power receiving device that is located on a charging surface of a wireless power transmitting device. The receiving device has a wireless power receiving coil and the transmitting device has a wireless power transmitting coil array. Control circuitry in the transmitting device uses inverter circuitry to supply alternating-current signals the coil array, thereby transmitting wireless power signals. Measurement circuitry coupled to the coil array makes impulse response measurements while the control circuitry uses the inverter circuitry to apply impulse signals to each of the coils. The control circuitry analyzes output from the measurement circuitry to detect the presence of a metal foreign object on the charging surface. In response to such a detection, the control circuitry reduces the power of subsequent impulse signals to minimize physical vibration and audible noise generated in the system by the metal foreign object.

This application claims the benefit of provisional patent application No. 62/661,966, filed Apr. 24, 2018, which is hereby incorporated by reference herein in its entirety.

### FIELD

This relates generally to wireless systems, and, more particularly, to systems in which devices are wirelessly charged.

### BACKGROUND

In a wireless charging system, a wireless power transmitting device such as a device with a charging surface wirelessly transmits power to a portable electronic device. The portable electronic device receives the wirelessly transmitted power and uses this power to charge an internal battery or to power the device. In some situations, foreign objects may be accidentally place on a charging surface. This can pose challenges when performing wireless power transmission operations.

### SUMMARY

A wireless power transmission system has a wireless power receiving device that is located on a charging surface of a wireless power transmitting device. The wireless power receiving device has a wireless power receiving coil and the wireless power transmitting device has a wireless power transmitting coil array. Control circuitry may use inverter circuitry in the wireless power transmitting device to supply alternating-current signals to coils in the coil array, thereby transmitting wireless power signals.

Impulse response measurement circuitry coupled to the coil array may make impulse response measurements while the control circuitry uses the inverter circuitry to apply impulse signals to each of the coils. The control circuitry analyzes measurements made with the impulse response measurement circuitry to characterize the environment over each of the coils (e.g., to detect the presence of the wireless power receiving device or foreign objects such as metal foreign objects on the wireless charging surface). In order to characterize the environment over a given coil in the coil array, the control circuitry controls the inverter circuitry using control signals of a first duty cycle to generate a first impulse signal having a first maximum power level on the given coil. The first impulse signal generates an impulse response on the given coil and the impulse response measurement circuitry gathers measurements such as frequency, peak power level, Q factor, and/or inductance measurements from the impulse response.

The impulse response measurement circuitry continues to gather impulse response measurements while the inverter circuitry supplies additional impulse signals to the given coil over time. The control circuitry compares the impulse response measurements to predetermined impulse response measurements to determine whether a metal foreign object, an inductive coil of a potential wireless power receiving device, or other materials are present on the charging surface and overlapping the given coil. In response to detecting that a metal foreign object is present, the control circuitry controls the inverter circuitry using control signals of a second duty cycle that is lower than the first duty cycle to generate additional impulse signals having a second maximum power level that is lower than the first maximum power level on the coil. This reduction in duty cycle and maximum power level minimizes or eliminates physical vibrations such as audible noise generated by the metal foreign object in response to the impulse signals. In response to detecting that an inductive coil is present, the control circuitry verifies that the inductive coil is part of a valid and compatible wireless power receiving device and, once verified, the control circuitry controls the inverter circuitry to transmit wireless power signals to the inductive coil to charge the wireless power receiving device.

In some configurations, in response to detecting that the impulse response measurements have changed over time, the control circuitry controls the inverter using a second duty cycle that is greater than the first duty cycle to generate a high power impulse signal having a second maximum power level that is greater than the first maximum power level. The control circuitry measures the impulse response on the coil from the high power impulse signal with the impulse response measurement circuitry. The control circuitry determines whether an inductive coil from a potential wireless power receiving device is present on the charging surface over the given coil based on the measured impulse response from the high power impulse signal. The control circuitry controls the inverter to generate subsequent impulse signals using the first (lower) maximum power level until another change is detected in the impulse response measurements.

### BRIEF DESCRIPTION OF THE DRAWINGS

FIG. 1 is a schematic diagram of an illustrative wireless charging system in accordance with embodiments.

FIG. 2 is a top view of an illustrative wireless power transmitting device with an array of coils that forms a wireless charging surface in accordance with an embodiment.

FIG. 3 is a circuit diagram of an illustrative wireless charging system in accordance with an embodiment.

FIG. 4 is a graph of an illustrative impulse response to an applied impulse signal in a wireless charging system in accordance with an embodiment.

FIG. 5 is a diagram showing how illustrative wireless power transmitting circuitry can include switching circuitry in accordance with an embodiment.

FIG. 6 is a flow chart of illustrative operations involved in operating a wireless power transfer system in accordance with an embodiment.

FIG. 7 is a flow chart of illustrative operations associated with adjusting an applied impulse signal based on the presence of a metal object in accordance with an embodiment.

FIG. 8 is a flow chart of illustrative operations associated with adjusting an applied impulse signal based on impulse response measurements in accordance with an embodiment.

FIG. 9 is a flow chart of illustrative operations associated with increasing power of an applied impulse signal in response to detecting a change in an impulse response measurement in accordance with an embodiment.

FIG. 10 is a table of illustrative impulse response measurements that are used in determining whether a metal object is present over a wireless power transmitting device in accordance with an embodiment.

### DETAILED DESCRIPTION

A wireless power system has a wireless power transmitting device that transmits power wirelessly to a wireless power receiving device. The wireless power transmitting device is a device such as a wireless charging mat, wireless charging puck, wireless charging stand, wireless charging table, or other wireless power transmitting equipment. The wireless power transmitting device has one or more coils that are used in transmitting wireless power to one or more wireless power receiving coils in the wireless power receiving device. The wireless power receiving device is a device such as a cellular telephone, watch, media player, tablet computer, pair of earbuds, remote control, laptop computer, other portable electronic device, or other wireless power receiving equipment.

During operation, the wireless power transmitting device supplies alternating-current drive signals to one or more wireless power transmitting coils. This causes the coils to transmit alternating-current electromagnetic signals (sometimes referred to as wireless power signals) to one or more corresponding coils in the wireless power receiving device. Rectifier circuitry in the wireless power receiving device converts received wireless power signals into direct-current (DC) power for powering the wireless power receiving device.

The position at which a wireless power receiving device is located on a wireless charging surface affects electromagnetic coupling (coupling coefficient k) between the coil(s) in the wireless power receiving device and each of the coils in the charging surface. The inductance of each transmitting coil may also be affected by the placement of the wireless power receiving device on the charging surface. For example, the inductance of a particular wireless power transmitting coil will increase when a wireless power receiving coil and the corresponding ferrite or other magnetic material in that coil overlaps the power transmitting coil. By making inductance measurements on the array of wireless power transmitting coils in a wireless power transmitting device, the location of one or more wireless power receiving coils relative to each of the wireless power transmitting coils can be determined.

Information on the size and orientation of the wireless power receiving device may also be determined. Based on the inductance measurements and other information, the settings of wireless power transmitting circuitry in the wireless power transmitting device may be adjusted to help enhance wireless power transfer operations. If desired, one or more coils in a wireless power transmitting device may be driven with appropriate weight(s), wireless power transmission limits may be established, content may be displayed on a display, and other actions may be taken. In some situations, incompatible objects such as coins or other foreign objects may be present in the vicinity of a wireless power receiving device. For example, a wireless power receiving device coil may overlap a foreign object. By comparing measured inductance values to predetermined valid sets of coil inductances, the presence of a foreign object may be detected so that wireless power transmission operations may be blocked or other suitable action taken.

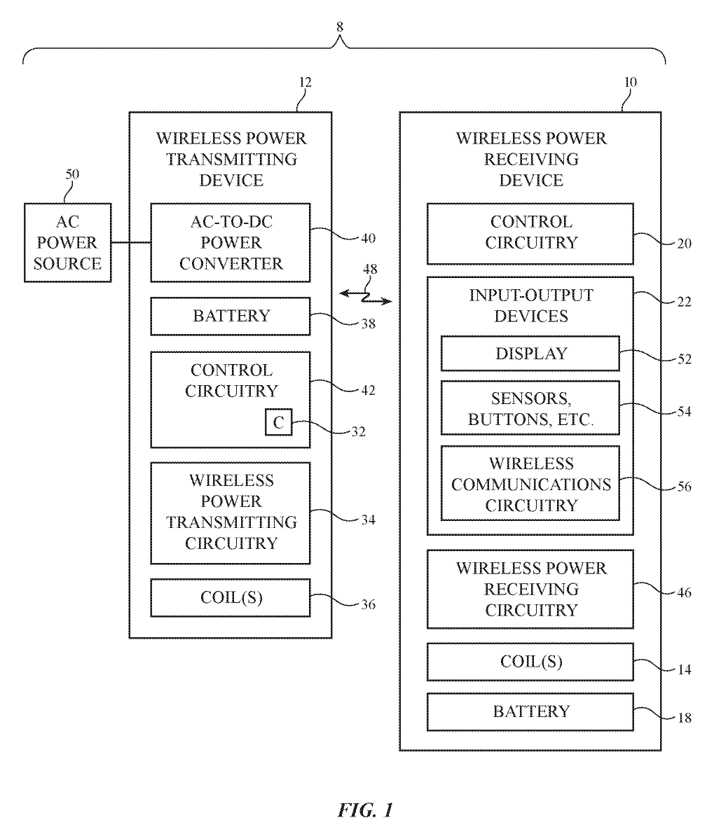

An illustrative wireless power system (wireless charging system) is shown in FIG. 1. As shown in FIG. 1, wireless power system 8 includes wireless power transmitting device 12 and one or more wireless power receiving devices such as wireless power receiving device 10. Device 12 may be a stand-alone device such as a wireless charging mat, may be built into furniture, or may be other wireless charging equipment. Device 10 is a portable electronic device such as a wristwatch, a cellular telephone, a tablet computer, or other electronic equipment. Illustrative configurations in which device 12 is a mat or other equipment that forms a wireless charging surface and in which device 10 is a portable electronic device that rests on the wireless charging surface during wireless power transfer operations are sometimes be described herein as examples.

During operation of system 8, a user places one or more devices 10 on the charging surface of device 12. Power transmitting device 12 is coupled to a source of alternating-current voltage such as alternating-current power source 50 (e.g., a wall outlet that supplies line power or other source of mains electricity), has a battery such as battery 38 for supplying power, and/or is coupled to another source of power. A power converter such as alternating-current-to-direct current (AC-DC) power converter 40 can convert power from a mains power source or other alternating-current (AC) power source into direct-current (DC) power that is used to power control circuitry 42 and other circuitry in device 12. During operation, control circuitry 42 uses wireless power transmitting circuitry 34 and one or more coil(s) 36 coupled to circuitry 34 to transmit alternating-current electromagnetic signals 48 to device 10 and thereby convey wireless power to wireless power receiving circuitry 46 of device 10.

Power transmitting circuitry 34 has switching circuitry (inverter circuitry) that supplies AC signals (drive signals) to one or more of coils 36 during wireless power transfer operations. One or more coils 36 may be used at a time for wireless power transfer. For example, a single coil 36 may supply power to a single receiving device that overlaps that coil, two coils 36 (e.g., adjacent coils) may supply power to a single device overlapping those two coils or to a pair of devices overlapping those coils, three or more coils may be driven to supply power to a single overlapping receiving device or to multiple overlapping receiving devices, two or more coils or three or more coils that are not adjacent to each other may be driven simultaneously to supply power to two or more or three or more devices at different respective locations on the coil array, etc.

The inverter circuitry that supplies the drive signals to coils 36 may include a single pair of transistors or other inverter circuit coupled to multiple coils 36 through multiplexer circuitry (e.g., to allow those transistors to be shared between multiple coils), may include a pair of transistors or other inverter circuit associated with each coil, and/or may include other inverter circuit arrangements that allow alternating-current drive signals to be supplied to one or more selected coils 36.

During power transfer operations, transistors in the inverter circuitry are turned on and off based on control signals provided by control circuitry 42. In configurations in which multiple coils have multiple respective inverter circuits, the transistors in the active coils (coils selected for wireless power transfer) may be turned on and off without turning on and off the transistors in the inactive coils. In configurations in which multiplexing circuitry is used to couple the inverter circuitry to selected coils, the multiplexing circuitry is configured appropriately to route AC signals from the inverter circuitry to the selected coils. As the AC signals pass through one or more coils 36 that have been selected for supplying wireless power, alternating-current electromagnetic fields (wireless power signals 48) are produced that are received by corresponding coil(s) 14 coupled to wireless power receiving circuitry 46 in receiving device 10. When the alternating-current electromagnetic fields are received by coil 14, corresponding alternating-current currents and voltages are induced in coil 14. Rectifier circuitry in circuitry 46 converts received AC signals (received alternating-current currents and voltages associated with wireless power signals) from coil(s) 14 into DC voltage signals for powering device 10. The DC voltages are used in powering components in device 10 such as display 52, touch sensor components and other sensors 54 (e.g., accelerometers, force sensors, temperature sensors, light sensors, pressure sensors, gas sensors, moisture sensors, magnetic sensors, etc.), wireless communications circuits 56 for communicating wirelessly with corresponding wireless communications circuitry 32 in control circuitry 42 of wireless power transmitting device 12 and/or other equipment, audio components, and other components (e.g., input-output devices 22 and/or control circuitry 20) and are used in charging an internal battery in device 10 such as battery 18.

Devices 12 and 10 include control circuitry 42 and 20. Control circuitry 42 and 20 include storage and processing circuitry such as microprocessors, power management units, baseband processors, digital signal processors, microcontrollers, and/or application-specific integrated circuits with processing circuits. Control circuitry 42 and 20 are configured to execute instructions for implementing desired control and communications features in system 8. For example, control circuitry 42 and/or 20 may be used in determining power transmission levels, processing sensor data, processing user input, processing other information such as information on wireless coupling efficiency from transmitting circuitry 34, processing information from receiving circuitry 46, using sensing circuitry to measure coil inductances and other parameters, processing measured inductance values, using information from circuitry 34 and/or 46 such as signal measurements on output circuitry in circuitry 34 and other information from circuitry 34 and/or 46 to determine when to start and stop wireless charging operations, adjusting charging parameters such as charging frequencies, coil settings (e.g., which coils are active and weights for active coils) in a multi-coil array, and wireless power transmission levels, and performing other control functions.

Control circuitry 42 and 20 may be configured to support wireless communications between devices 12 and 10 (e.g., control circuitry 20 may include wireless communications circuitry such as circuitry 56 and control circuitry 42 may include wireless communications circuitry such as circuitry 32). Control circuitry 42 and/or 20 may be configured to perform these operations using hardware (e.g., dedicated hardware or circuitry) and/or software (e.g., code that runs on the hardware of system 8). Software code for performing these operations is stored on non-transitory computer readable storage media (e.g., tangible computer readable storage media). The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, other computer readable media, or combinations of these computer readable media or other storage. Software stored on the non-transitory computer readable storage media may be executed on the processing circuitry of control circuitry 42 and/or 20. The processing circuitry may include application-specific integrated circuits with processing circuitry, one or more microprocessors, or other processing circuitry.

Device 12 and/or device 10 may communicate wirelessly during operation of system 8. Devices 10 and 12 may, for example, have wireless transceiver circuitry in control circuitry 20 and 42 (see, e.g., wireless communications circuitry such as circuitry 56 and 32 of FIG. 1) that allows wireless transmission of signals between devices 10 and 12 (e.g., using antennas that are separate from coils 36 and 14 to transmit and receive unidirectional or bidirectional wireless signals, using coils 36 and 14 to transmit and receive unidirectional or bidirectional wireless signals, etc.).

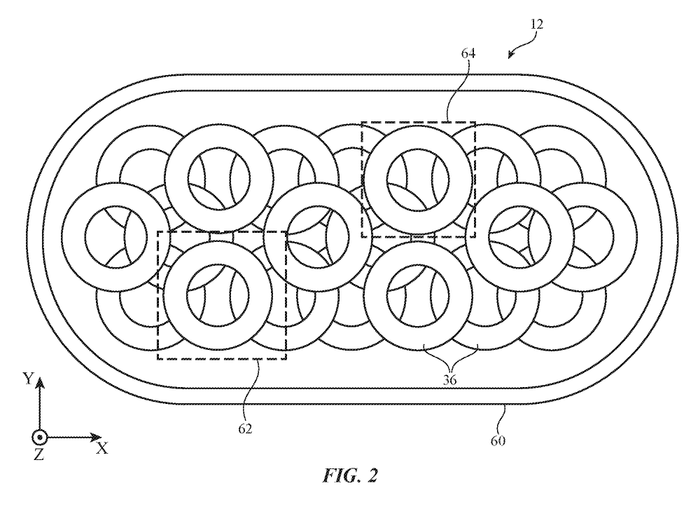

With one illustrative configuration, wireless power transmitting device 12 is a wireless charging mat or other wireless power transmitting equipment that has an array of coils 36 that supply wireless power over a wireless charging surface. This type of arrangement is shown in FIG. 2. In the example of FIG. 2, device 12 has an array of coils 36 that lie in the X-Y plane. Coils 36 of device 12 are covered by a planar dielectric structure such as a plastic member or other structure forming charging surface 60. The lateral dimensions (X and Y dimensions) of the array of coils 36 in device 36 may be 1-1000 cm, 5-50 cm, more than 5 cm, more than 20 cm, less than 200 cm, less than 75 cm, or other suitable size. Coils 36 may overlap or may be arranged in a non-overlapping configuration. Coils 36 can be placed in a rectangular array having rows and columns and/or may be tiled using a hexagonal tile pattern or other pattern.

During operation, a user places one or more devices 10 on charging surface 60 in locations such as locations 62 and 64. The position at which a device 10 is located on surface 60 affects alignment between the coil 14 in that device (FIG. 1) and coil(s) 36 in device 12. Variations in alignment, in turn, affect magnetic coupling (coupling coefficient k) between the coils in devices 12 and 10. In addition to variations in coupling coefficient k, the amount of power that is desired by device 10 at any given point in time may vary. For example, device 10 may wish to draw a relatively large amount of power to charge battery 18 when battery 18 is depleted and may wish to draw a relatively small amount of power when battery 18 is fully charged. Due to variations in operating conditions in system 8 such as changes in coupling coefficient k and desired power draw (desired rectifier output power) in device 10, wireless charging system performance will vary. As an example, wireless power transfer efficiency will vary as operating conditions change. System 8 therefore makes real-time adjustments to system operating parameters such as the duty cycle of the alternating-current drive signal that drives current through coil(s) 36. These adjustments may help enhance wireless power transfer efficiency while supplying a battery charger or other components in device 10 with desired amounts of power.

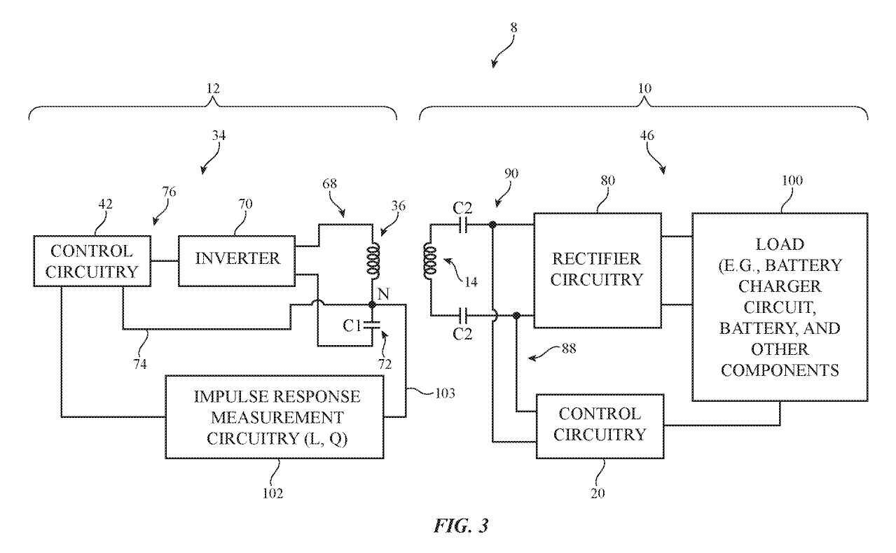

A circuit diagram of illustrative circuitry for wireless power transfer (wireless power charging) system 8 is shown in FIG. 3. As shown in FIG. 3, wireless power transmitting circuitry 34 includes an inverter such as inverter 70 or other drive circuit that produces alternating-current drive signals such as variable-duty-cycle square waves or other drive signals. These signals are driven through an output circuit such as output circuit 68 that includes coil(s) 36 and capacitor(s) 72 to produce wireless power signals that are transmitted wirelessly to device 10.

Coil(s) 36 are electromagnetically coupled with coil(s) 14. A single coil 36 and single corresponding coil 14 are shown in the example of FIG. 2. In general, device 12 may have any suitable number of coils (1-100, more than 5, more than 10, fewer than 40, fewer than 30, 5-25, etc.) and device 10 may have any suitable number of coils. Switching circuitry (sometimes referred to as multiplexer circuitry) that is controlled by control circuitry 42 can be located before and/or after each coil (e.g., before and/or after each coil 36 and/or before and/or after the other components of output circuit 68 in device 12) to couple the array of coils to inverter 70 and can be used to switch desired sets of one or more coils (e.g., coils 36 and output circuits 68 in device 12) into or out of use. For example, if it is determined that device 10 is located in location 62 of FIG. 2, the coil(s) overlapping device 10 at location 62 may be activated during wireless power transmission operations while other coils 36 (e.g., coils not overlapped by device 10 in this example) are turned off.

Control circuitry 42 and control circuitry 20 contain wireless transceiver circuits (e.g., circuits such as wireless communication circuitry 56 and 32 of FIG. 1) for supporting wireless data transmission between devices 12 and 10. In device 10, control circuitry 20 (e.g., communications circuitry 56) can use path 88 and coil 14 to transmit data to device 12. In device 12, paths such as path 74 may be used to supply incoming data signals that have been received from device 10 using coil 36 to demodulating (receiver) circuitry in wireless communications circuitry 32 of control circuitry 42. If desired, path 74 may be used in transmitting wireless data to device 10 with coil 36 that is received by receiver circuitry in circuitry 56 of circuitry 20 using coil 14 and path 88. Configurations in which wireless communications circuitry 56 of circuitry 20 and wireless communications circuitry 32 of circuitry 42 have antennas that are separate from coils 36 and 14 may also be used for supporting unidirectional and/or bidirectional wireless communications between devices 12 and 10 (e.g., in frequency bands such as wireless local area network frequency bands, wireless personal area network frequency bands, etc.), if desired.

During wireless power transmission operations, transistors in inverter 70 are controlled using AC control signals from control circuitry 42. Control circuitry 42 uses control path 76 to supply control signals to the gates of the transistors in inverter 70. The duty cycle and/or other attributes of these control signals and therefore the corresponding characteristics of the drive signals applied by inverter 70 to coil 36 and the corresponding wireless power signals produced by coil 36 can be adjusted dynamically. Using switching circuitry, control circuitry 42 selects which coil or coils to supply with drive signals. Using duty cycle adjustments and/or other adjustments (e.g., drive frequency adjustments, etc.), control circuitry 42 can adjust the strength of the drive signals applied to each coil. A single selected coil may be used in transmitting power wirelessly from device 12 to device 10 or multiple coils 36 may be used in transmitting power. One or more devices 10 may receive wireless power and each of these devices may have one or more wireless power receiving coils that receive power from one or more corresponding wireless power transmitting coils.

Wireless power receiving device 10 has wireless power receiving circuitry 46. Circuitry 46 includes rectifier circuitry such as rectifier 80 (e.g., a synchronous rectifier controlled by signals from control circuitry 20) that converts received alternating-current signals from coil 14 (e.g., wireless power signals received by coil 14) into direct-current (DC) power signals for powering circuitry in device 10 such as load 100. Load circuitry such as load 100 may include battery 18, a power circuit such as a battery charging integrated circuit or other power management integrated circuit(s) that receives power from rectifier circuitry 80 and regulates the flow of this power to battery 18, and/or other input-output devices 22 (FIG. 1). As shown in FIG. 3, one or more capacitors C2 are used to couple coil 14 in input circuit 90 of device 10 to input terminals for rectifier circuitry 80. Rectifier circuitry 80 produces corresponding output power at output terminals that are coupled to load 100. If desired, load 100 may include sensor circuitry (e.g., current and voltage sensors) for monitoring the flow of power to load 100 from rectifier 80.

The inductance L of each wireless power transmitting coil 36 in device 12 can be affected (e.g., increased) by the presence of overlapping coil(s) 14 and associated magnetic material (e.g., ferrite core material, etc.) in device 10. The location(s) of coil(s) 14 can therefore be determined by making inductance measurements on each of coils 36 and processing these measurements (e.g., using interpolation techniques, etc.). In situations in which a metal coin or other foreign object is present on the coil array (e.g., under coil 14 or elsewhere on the coil array), the presence of the foreign object may be detected by comparing the measured inductances of coils 36 to predetermined valid sets of coil inductances. If a match between a set of measured inductances and valid set of previously measured inductances is detected, it can be concluded that only device 10 is present and that no foreign objects are present, so wireless power transmission operations may be performed. If no match is detected, it can be concluded that a foreign object is likely to be present and wireless power transmission operations may be blocked (e.g., no wireless power transmission operations may be performed) or other suitable action may be taken (e.g., a visual alert may be issued for a user using a light-emitting component such as a status indicator light-emitting diode, a display, etc., an audible alert may be issued using a sound-emitting component such as a tone generator or speaker, a haptic alert may be issued using a haptic device such as a vibrator), and/or other actions may be taken.

During wireless power transmission operations, transistors in inverter 70 are driven by AC control signals from control circuitry 42. Control circuitry 42 may also use inverter 70 to apply square wave impulse pulses or other impulse signals to each coil 36 during impulse response measurements. Impulse response measurement circuitry 102 is coupled to output circuit 68. For example, circuitry 102 may be coupled to node N in output circuit 68 using path 103. Control circuitry 42 uses impulse response measurement circuitry 102 to make measurements on output circuit 68 (e.g., measurements on the inductance L of coil 36, measurements of quality factor Q, etc.).

Each coil 36 in device 12 (e.g., a coil such as coil 36 of FIG. 3 that has been selected by control circuitry 42 using multiplexing circuitry in wireless power transmitting circuitry 34) has an inductance L. One or more capacitors in output circuit 68 such as capacitor 72 exhibit a capacitance C1 that is coupled in series with inductance L in output circuit 68. When supplied with alternating-current drive signals from inverter 70, the output circuit formed from coil 36 and capacitor 72 will produce alternating-current electromagnetic fields that are received by coil(s) 14 in device 10. The inductance L of each coil 36 is influenced by magnetic coupling with external objects, so measurements of inductance L for each coil 36 in device 12 can reveal information on external objects such as device(s) 10 or foreign objects on the charging surface of device 12.

During impulse response measurements, control circuitry 42 directs inverter 70 to supply one or more excitation pulses (impulses) to each coil 36, so that the inductance L of coil 36 and capacitance C1 of the capacitor 72 in the output circuit 68 that includes that coil 36 form a resonant circuit. The impulses may sometimes be referred to herein as impulse signals, excitation pulses, ping signals, pings, or impulse pings. The impulse signals may be, for example, square wave pulses of 1 μs in duration. Longer or shorter pulses and/or pulses of other shapes may be applied, if desired. The resonant circuit resonates at a frequency near to the normal wireless charging frequency of coil 36 (e.g., about 120 kHz, 50-300 kHz, about 240 kHz, 100-500 kHz, more than 75 kHz, less than 400 kHz, or other suitable wireless charging frequency) or may resonate at other frequencies in response to the supplied impulse signal. In contrast to wireless charging signals that are used to power device 10, the impulse signals generally are not used to power device 10, are provided at lower power levels, and are used for performing impulse response measurements for coil 36, as examples.

Control circuitry 42 may adjust the duty cycle of the control signals supplied to inverter 70 to dynamically adjust the power of the impulse signals supplied to coil 36. For example, control circuitry 42 may control inverter 70 using a relatively low duty cycle so that the impulse signals are supplied to coil 36 at a relatively low power level and may control inverter 70 using a relatively high duty cycle so that the impulse signals are supplied to coil 36 at a relatively high power level. During the impulse response measurements, circuitry 42 uses impulse response measurement circuitry 102 (sometimes referred to as inductance measurement circuitry and/or Q factor measurement circuitry) to perform measurements of inductance L and quality factor Q (sometimes referred to herein as Q factor). Circuitry 102 also performs impedance measurements, resonant frequency measurements, resistance measurements, and/or other measurements if desired.

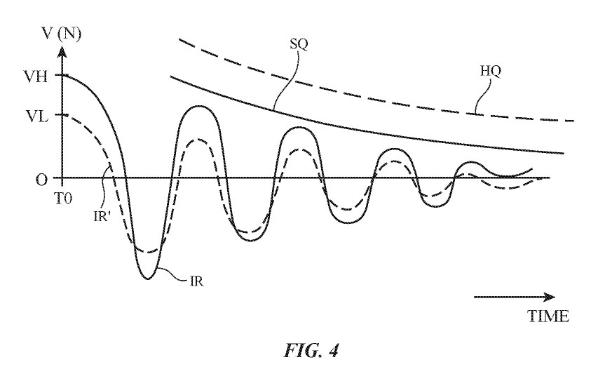

An impulse signal supplied to (driven onto) coil 36 generates a corresponding impulse response on coil 36 and capacitor 72. An illustrative impulse response to an impulse signal supplied to coil 36 (e.g., the voltage V(N) at node N of circuit 68) is shown in FIG. 4. The frequency of the impulse response signal of FIG. 4 is proportional to 1/sqrt(L*C1), so L can be obtained from the known value of C1 and the measured frequency of the impulse response signal. Q may be derived from L and the measured decay of the impulse response signal. As shown in FIG. 4, if signal V(N) decays slowly, Q is high (e.g., HQ) and if signal V(N) decays more rapidly, Q is low (e.g., SQ). Measurement of the decay envelope of V(N) and frequency of V(N) of the impulse response signal of FIG. 4 with circuitry 102 will therefore allow control circuitry 42 to determine Q and L.

In scenarios where a metal foreign object is present above coil 36, the impulse signal applied to coil 36 can generate an electromagnetic response in the metal object (e.g., a reactive current) that causes structures within wireless power transmitting device 12 and/or wireless power receiving device 10 to physically vibrate. This physical vibration may be audible to a user of wireless charging system 8 as an unpleasant or distracting buzzing or ticking noise, particularly when the impulse signals are provided to coil 36 relatively frequently (e.g., every few microseconds).

In order to mitigate these issues during impulse response measurement, control circuitry 42 (FIG. 3) controls inverter 70 to reduce the power level of the impulse signals supplied to coil 36 (e.g., by reducing the duty cycle of the control signals supplied to inverter 70). In practice, lower power impulse signals will generate a smaller electromagnetic response in the metal foreign object and thus less physical vibration in devices 10 and 12 than higher power impulse signals. At the same time, lower power impulse signals can limit the reliability of the impulse response measurements more than higher power impulse signals. By reducing the power level of the impulse response signals, control circuitry 42 can sacrifice some reliability in the impulse response measurements to reduce audible noise generated by the presence of the foreign metal object over coil 36.

As shown in FIG. 4, in the absence of a metal foreign object over coil 36, control circuitry 42 controls inverter 70 (FIG. 3) to supply a first impulse signal to coil 36 at a relatively high power level at or just before time TO (e.g., by controlling inverter 70 using a relatively high duty cycle while generating the first impulse signal). Curve IR of FIG. 4 illustrates the impulse response at node N in response to this high power impulse signal. The impulse response exhibits a peak (maximum) magnitude VH at time TO and is subject to a decay after time TO that is characterized by Q (e.g., a relatively high Q such as HQ or a relatively low Q such as SQ).

When a metal foreign object is present over coil 36, control circuitry 42 controls inverter 70 to supply a second impulse signal to coil 36 at a relatively low power level at or just before time TO (e.g., by controlling inverter 70 using a relatively low duty cycle while generating the second impulse signal). Curve IR′ illustrates the impulse response at node N in response to this relatively low power impulse signal. The relatively low duty cycle may be 7-10% lower than the relatively high duty cycle associated with curve IR, 5-15% lower, 5-30% lower, 1-30% lower, more than 30% lower, or any other desired duty cycle that is lower than the relatively high duty cycle, as examples. The impulse response exhibits a peak (maximum) magnitude that is VL at time TO and is subject to a decay after time TO as characterized by Q. The reduction in peak power from VH to VL reduces electromagnetic excitation of the metal foreign object to minimize or eliminate audible vibrations in wireless charging system 8.

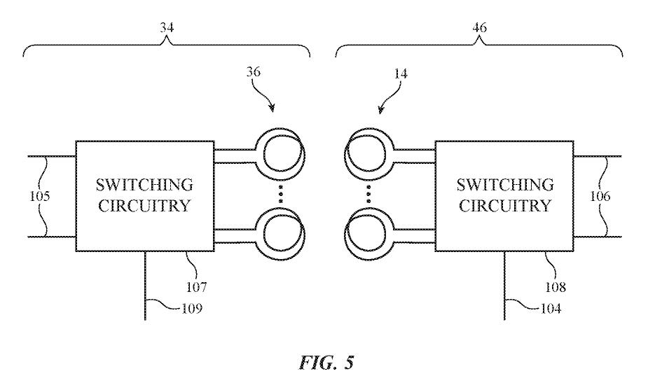

FIG. 5 shows how wireless power transmitting circuitry 34 includes switching circuitry 107. Signals from inverter circuitry 70 (FIG. 3) are applied to switching circuitry 107 at input 105. Switching circuitry 107 forms part of wireless power transmitting circuitry 34. Control signals applied to control input 109 by control circuitry 42 direct switching circuitry 107 to route the signals from input 105 to a selected one of coils 36 in the array of coils 36 in device 12. Wireless power receiving circuitry 46 of device 10 includes one or more coils 14. In configurations for device 10 that include multiple coils 14, coils 14 are coupled to switching circuitry 108. Control circuitry 20 applies control signals to control input 104 that direct switching circuitry 108 to route signals from a selected one of coils 14 to rectifier 80 via output terminals 106.

When a user places device 10 on charging surface 60 (FIG. 2), coil 14 (or multiple coils 14 in configurations in which device 10 contains multiple coils) will overlap one or more coils 36. Control circuitry 42 uses inverter 70 (FIG. 3) and switching circuitry 107 (FIG. 5) to supply impulse signals to each of coils 36 under charging surface 60. Impulse response measurement circuitry 102 and switching circuitry 107 measure the impulse response (e.g., as shown by curves IR and IR′ of FIG. 4) for each of coils 36 under charging surface 60. Impulse response measurement circuitry 102 gathers measurements of L, Q, frequency, and/or other impulse response measurements for each of coils 36. If the impulse response measurements (e.g., measurements of L, Q, frequency, etc.) for a given coil matches the normal (nominal) values expected for each of coils 36 in the array of coils 36 overlapping surface 60 (e.g., when the impulse response measurements are not influenced by the presence of coil 14, other portions of device 10, for foreign objects), control circuitry 42 can conclude that no external object is present (e.g., that coils 36 are in a free space operating environment). If the impulse response measurements are different than the nominal values of the impulse response measurements, control circuitry 42 can conclude that a portion of the housing of device 10 is present, that coil 14 is present, that a non-metal foreign object is present, or that a metal foreign object is present. If the impulse response measurements for a given coil 36 match impulse response measurements expected for each of the coils 36 in scenarios where a metal foreign object is present, control circuitry 42 can conclude that a metal foreign object is present and can subsequently reduce the power of subsequent impulse signals. Metal foreign objects can include any object having metal or metallic structures other than inductive coils (i.e., the metal foreign objects are not used for wirelessly powering another device). Metal foreign objects can include metallic portions of device 10, metallic portions of other devices, metal keys, metal badges, metallic credit cards, coins, or any other metal objects.

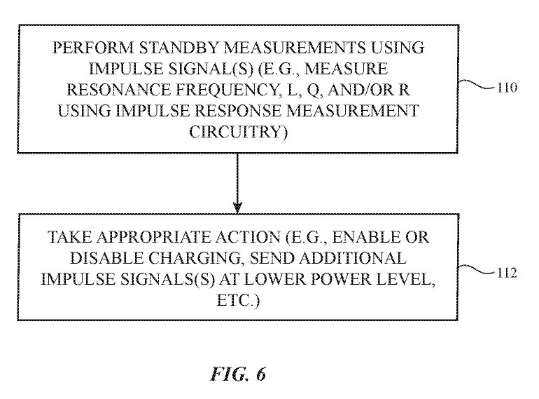

FIG. 6 is a flow chart of illustrative operations involved in using system 8. During the operations of block 110, system 8 performs standby measurements. For example, device 12 may use circuitry such as impulse response measurement circuitry 102 of FIG. 3 to monitor one or more coils 36 (e.g., each coil 36 or a subset of the coils 36 in the array of coils 36 in device 12) for the presence of an external object such as a device that is potentially compatible for wireless power transfer (e.g., device 10) or an incompatible foreign object such as a metal object (e.g., a coin, a badge, keys, a metal portion of a housing of device 10, a device that is not compatible with the wireless charging functionality of device 12, etc.). The standby operations of block 110 consume a relatively low amount of power (e.g., 50 mW or less, 100 mW or less, more than 1 mW, or other suitable amounts).

Device 12 may perform impulse response measurements during the operations of block 110. For example, control circuitry 42 may use inverter 70 (FIG. 3) or other resonant circuit drive circuitry to apply a stimulus (e.g., an impulse signal) to the circuit formed from one or more of coils 36 (e.g., to each coil 36 in the array of coils 36 in device 12, a subset of these coils such as those for which foreign object presence has been detected during the operations of block 120, and/or other suitable sets of one or more of coils 36), thereby causing that circuit (and that coil 36) to resonate while using a measurement circuit such as impulse response measurement circuitry 102 to measure the impulse response of the resonant circuit. As described in connection with FIG. 4, the characteristics of the resulting circuit resonance (i.e., the impulse response) may then be measured and analyzed. For example, control circuitry 42 may use information on the measured resonant frequency to measure inductance and may use information on the decay of the signal resonance to determine resistance R and Q factor.

During the operations of block 110, device 12 may characterize the environment above coils 36 based on the impulse response measurements. For example, device 12 may compare the impulse response measurements to predetermined expected measurements associated with different environments such as a first environment where no object is over coils 36, a second environment where coil 14 of device 10 is over coils 36, a third environment where a metal foreign object is over coils 36, a fourth environment where a non-metal foreign object is over coils 36, etc.

Appropriate actions are taken during the operations of block 112 based on the results of impulse response measurements of block 110. If, as an example, a foreign object is detected, wireless charging operations with all of coils 36 or an appropriate subset of coils 36 can be blocked. In response to detection of an electronic device 10 having a known characteristic L response (and/or Q response) after checking one or more of coils 36 (e.g., the coils 36 for which L and/or Q measurements and/or other measurements indicate may be overlapped by an object or all of coils 36), control circuitry 42 can use wireless power transmitting circuitry 34 to transmit wireless power to wireless power receiving circuitry 46. In response to detection of the absence of electronic device 10 (e.g., the presence of a non-metal foreign object or the absence of any external objects), device 12 may continue to perform standby measurements such as impulse response measurements (e.g., processing may loop back to block 110). In response to detection of a metal foreign object, device 10 may gather additional impulse response measurements in response to impulse response signals at lower power levels (e.g., processing may loop back to block 110 and additional impulse signals having a lower peak magnitude may be supplied to coils 36).

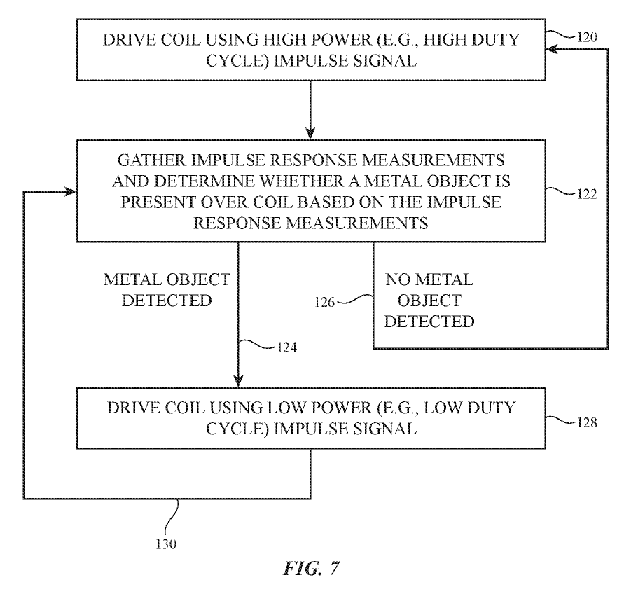

FIG. 7 is a flow chart of illustrative operations involved in adjusting impulse signal power level in response to detecting a metal foreign object over coils 36. The blocks of FIG. 7 may be performed by device 12 for one or more coils 36 (e.g., for each coil 36 or a subset of the coils 36 in sequence and/or in parallel).

During the operations of block 120, inverter 70 drives coil 36 using a relatively high power impulse signal. For example, control circuitry 42 may control inverter 70 to generate the high power impulse signal using a relatively high duty cycle (e.g., an impulse signal supplied to coil 36 at approximately time TO and having a peak magnitude of approximately VH as shown in FIG. 4). Coil 36 and capacitor 72 (FIG. 3) subsequently resonate in response to the high power impulse signal. As an example, the high power impulse signal may generate an impulse response such as impulse response IR of FIG. 4 on coil 36 (e.g., an impulse response having a peak magnitude VH and subject to a decay over time).

Impulse response measurement circuitry 102 measures the impulse response of coil 36 while coil 36 resonates (block 122). During the operations of block 122, impulse response measurement circuitry 102 measures the characteristics (i.e., gathers impulse response measurements) from the impulse response produced on coil 36 by the high power impulse signal. Impulse response measurement circuitry 102 analyzes the gathered impulse response measurements to determine whether a metal foreign object is present on charging surface 60 over the corresponding coil 36 (e.g., by comparing the gathered impulse response measurements to predetermined measurements known to be associated with presence of a metal object). For example, control circuitry 42 gathers measurements of the resonant frequency, inductance, Q factor, and/or resistance of coil 36 (e.g., based on impulse response IR as shown in FIG. 4) and compares one or more of these measurements to corresponding predetermined measurement values that are expected to be produced in response to the presence of a metal foreign object over coil 36. The predetermined measurement values may be identified through calibration of device 12 (e.g., during manufacture, in factory, in the field, etc.). If the gathered measurements match the predetermined measurement values (e.g., if the difference between one or more of the gathered measurements and the predetermined measurement values is less than a corresponding threshold value), control circuitry 42 determines that a metal foreign object is present on charging surface 60 over coil 36. If the gathered measurements do not match the predetermined measurement values (e.g., if the difference between the gathered measurements and the predetermined measurement values is greater than or equal to a corresponding threshold value), control circuitry 42 determines that no metal foreign object is present on charging surface 60 over coil 36.

If control circuitry 42 does not detect a metal foreign object while performing the operations of block 122, processing loops back to block 120 as shown by path 126. Control circuitry 42 continues to supply impulse signals to coil 36 to detect whether there is a change in the environment above coil 36 over time (e.g., to detect whether a metal foreign object is eventually placed over coil 36). If control circuitry 42 detects a metal object while performing the operations of block 122, processing proceeds to block 128 as shown by path 124.

During the operations of block 128, inverter 70 drives coil 36 using a relatively low power impulse signal (i.e., control circuitry 42 reduces the duty cycle provided to inverter 70 and thus the power level of the impulse signal in response to detecting that a foreign metal object is present on charging surface 60 over coil 36). Coil 36 and capacitor 72 (FIG. 3) subsequently resonate in response to the low power impulse signal. As an example, control circuitry 42 may control inverter 70 to generate the low power impulse signal at approximately time TO with a peak magnitude of VL as shown in FIG. 4. The low power impulse signal generates an impulse response such as impulse response IR′ of FIG. 4 on coil 36 (e.g., an impulse response having a peak magnitude VL and subject to a decay over time). Processing subsequently loops back to block 122 as shown by path 130. Control circuitry 42 continues to gather impulse response measurements to determine whether the metal foreign object has been removed from or has otherwise moved away from coil 36. Control circuitry 42 continues to drive coil 36 using low power impulse signals until the metal foreign object is no longer present over coil 36.

In this way, device 12 ensures that a relatively low power impulse signal is applied to coil 36 when a metal foreign object is placed over coil 36. This limits electromagnetic excitation of the metal foreign object by the impulse signal and thus the corresponding physical vibrations and audible noise produced by the presence of the metal object over coil 36. Control circuitry 42 concurrently uses the impulse signals (e.g., the high power impulse signals of block 120 and the low power impulse signals of block 128) to determine whether coil 14 of device 10 has moved above coil 36 over time (e.g., so that coil 36 can be used to transfer wireless power to device 10 when coil 14 is over coil 36).

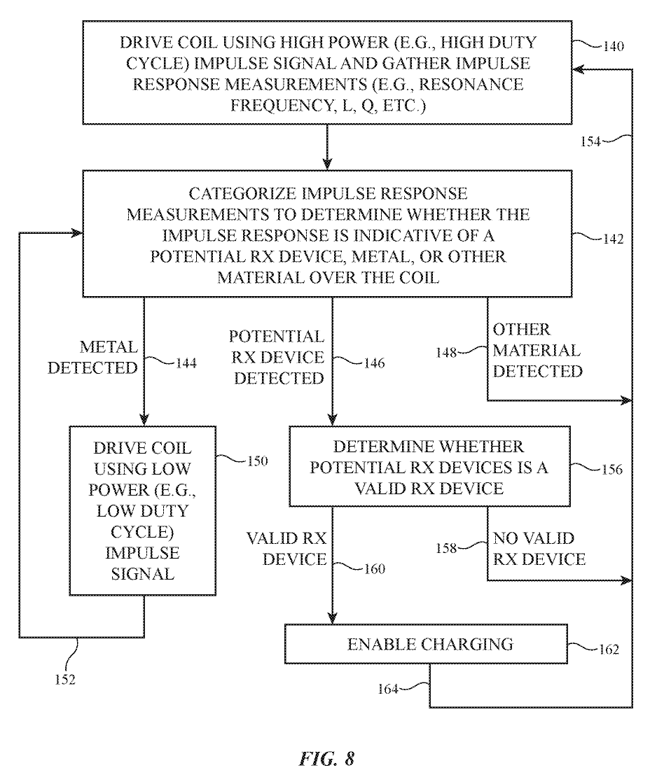

FIG. 8 is a flow chart of illustrative operations involved in adjusting impulse signal power level while concurrently monitoring for the presence of coil 14 over coils 36. The blocks of FIG. 8 may be performed by device 12 for one or more coils 36 (e.g., for each coil 36 or a subset of the coils 36 in sequence and/or in parallel).

During the operations of block 140, inverter 70 drives coil 36 using a relatively high power impulse signal. Control circuitry 42 provides control signals to inverter 70 using a relatively high duty cycle to generate the high power impulse signal. Coil 36 and capacitor 72 (FIG. 3) subsequently resonate in response to the high power impulse signal. Impulse response measurement circuitry 102 gathers impulse response measurements while coil 36 resonates. The impulse response measurements include measurements of frequency, inductance, Q factor, resistance of coil 36, and/or other measurements.

During the operations of block 142, impulse response measurement circuitry 102 and/or control circuitry 42 analyze the gathered impulse response measurements to categorize (characterize) the environment over coil 36 (e.g., control circuitry 42 uses the gathered impulse response measurements to determine whether coil 14 of device 10 is over coil 36, whether a metal foreign object is over coil 36, whether a ferromagnetic material is over coil 36, whether any other material is over coil 36, etc.). Control circuitry 42 compares the impulse response measurements to sets of predetermined measurement values (e.g., sets of values stored on device 12) that are each associated with (e.g., expected to be gathered for) a corresponding environment over coil 36.

For example, control circuitry 42 may compare the impulse response measurements to a first set of predetermined measurement values expected for a metal foreign object over coil 36, a second set of predetermined measurement values expected for an inductive coil such as 14 of device 10 over coil 36, a third set of predetermined measurement values expected for ferromagnetic material over coil 36, a fourth set of predetermined measurement values for all other environments over coil 36, and/or additional sets of predetermined measurement values. Control circuitry 42 categorizes the operating environment over coil 36 by determining whether one or more of the gathered impulse response measurements matches any of the sets of predetermined measurement values. If the gathered impulse response measurements match any of the sets of predetermined measurement values (e.g., if the gathered impulse response measurements are within a selected margin of the predetermined measurement values in each set), control circuitry 42 determines that the operating environment corresponding to the matching set of predetermined measurement values is present on charging surface 60 over coil 36.

If the gathered impulse response measurements match a set of predetermined measurement values expected for a metal foreign object over coil 36, control circuitry 42 determines that a metal foreign object is present on charging surface 60 over coil 36 and processing proceeds to block 150 as shown by path 144. During the operations of block 150, inverter 70 drives coil 36 using a relatively low power impulse signal to minimize or eliminate physical vibration and audible noise generated by the metal foreign object from the impulse response signal. The low power impulse signal causes coil 36 to resonate. Impulse response measurement circuitry 102 (FIG. 3) gathers impulse response measurements while coil 36 resonates. Processing subsequently loops back to block 142 so that control circuitry 42 continues to monitor the environment over coil 36 and adjusts the impulse signal accordingly (i.e., based on the environment over coil 36).

If the gathered impulse response measurements match a set of predetermined measurement values expected for an inductive coil such as coil 14 of device 10, control circuitry 42 determines that a potential wireless power receiving (RX) device is present on charging surface 60 over coil 36 and processing proceeds to block 156 as shown by path 146. If the gathered impulse response measurements do not match the set of predetermined measurement values expected for an inductive coil or the set predetermined measurement values expected for a metal foreign object (i.e., if control circuitry 42 detects an object other than a metal foreign object or inductive coil over coil 36), processing loops back to block 140 as shown by paths 148 and 154. In this scenario, inverter 70 continues to drive coil 36 using high power impulse signals without risk of physical vibrations and audible noise (because no metal object is present on charging surface 60 over coil 36) until either coil 14 or a metal foreign object is placed over coil 36.

During the operations of block 156 (i.e., in response to determining that an inductive coil and thus a potential wireless power receiving device is present on charging surface 60 over coil 36), control circuitry 42 determines whether the potential wireless power receiving device over coil 36 is a valid wireless power receiving device such as wireless power receiving device 10 of FIG. 1 (e.g., a wireless power receiving device compatible with wireless power transmitting device 12). Control circuitry 42 uses path 74 (FIG. 3) to transmit wireless data (e.g., modulated wireless data) to the potential wireless power receiving device with coil 36. If the potential wireless power receiving device is a valid wireless power receiving device, the wireless power receiving device will supply the incoming data signals that have been provided by coil 36 to demodulating (receiver circuitry) on the wireless power receiving device such as communications circuitry 32 of control circuitry 42 of wireless power receiving device 10. The wireless power receiving device will then transmit a corresponding data signal (e.g., a corresponding response signal or hand-shake signal) to coil 36 over coil 14. Path 74 conveys the response signal to control circuitry 42 on device 12. Control circuitry 42 will demodulate the response signal and process the demodulated response signal to identify that the potential wireless power receiving device is a valid (compatible) wireless power receiving device such as device 10 of FIG. 1. If no such response signal is received or if an incompatible response signal is received, control circuitry 42 may determine that the potential wireless power receiving device is not a valid wireless power receiving device (e.g., the potential wireless power receiving device may be operable under a different wireless charging protocol or may be another device having an inductive coil or similar structure that is not used for performing wireless charging). Configurations in which communications circuitry 56 and communications circuitry 32 of control circuitry 42 have antennas that are separate from coils 36 and 14 may also be used for supporting the determination of whether the potential wireless power receiving device is a valid wireless power receiving device, if desired.

In response to determining that a valid wireless power receiving device is present on charging surface 60 over coil 36 (e.g., in response to determining that coil 14 of wireless power receiving device 10 is present on charging surface 60 over coil 36), processing proceeds to block 162 as shown by path 160. During the operations of block 162, control circuitry 42 enables wireless power transmission to wireless power receiving device 10. During wireless power transmission operations, transistors in inverter 70 are driven by AC control signals from control circuitry 42. The AC control signals may control inverter 70 to apply drive signals to coil 36 (e.g., signals having a higher power than the impulse signals) that generate corresponding alternating-current electromagnetic signals 48 that are transmitted to coil 14 on device 10 (FIG. 1). Rectifier 80 on device 10 converts the received alternating-current signals from coil 14 into direct-current (DC) power signals for powering circuitry in device 10 such as load 100 (FIG. 3). Processing subsequently loops back to block 140 as shown by paths 164 and 154. In this way, control circuitry 42 continues to periodically transmit impulse signals while also conveying wireless power to device 10. Control circuitry 42 uses the impulse signals to identify when coil 14 of device 10 has moved away from coil 36 and adjusts the impulse signals accordingly (e.g., once charging has been enabled, path 146 may loop back to block 140 and blocks 156 and 162 may be omitted until coil 14 of device 10 has moved away from coil 36).

In response to determining that a valid wireless power receiving device is not present over coil 36 (while processing the operations of block 156), processing loops back to block 140 as shown by paths 158 and 154. Impulse signals conveyed to a potential wireless power receiving device (e.g., an inductive coil) does not generate the physical vibrations and audible noise associated with the presence of metal foreign object, so control circuitry 42 continues to use high power impulse signals in this scenario. Use of high power impulse signals generally allows for more reliable categorization of the environment over coil 36. However, driving coil 36 using high power impulse signals until a metal object is detected can consume excessive power in device 12. To mitigate these issues, a configuration in which control circuitry 42 controls inverter 70 to supplying low power impulse signals to coil 36 until a change in the environment over coil 36 is detected may be used, if desired.

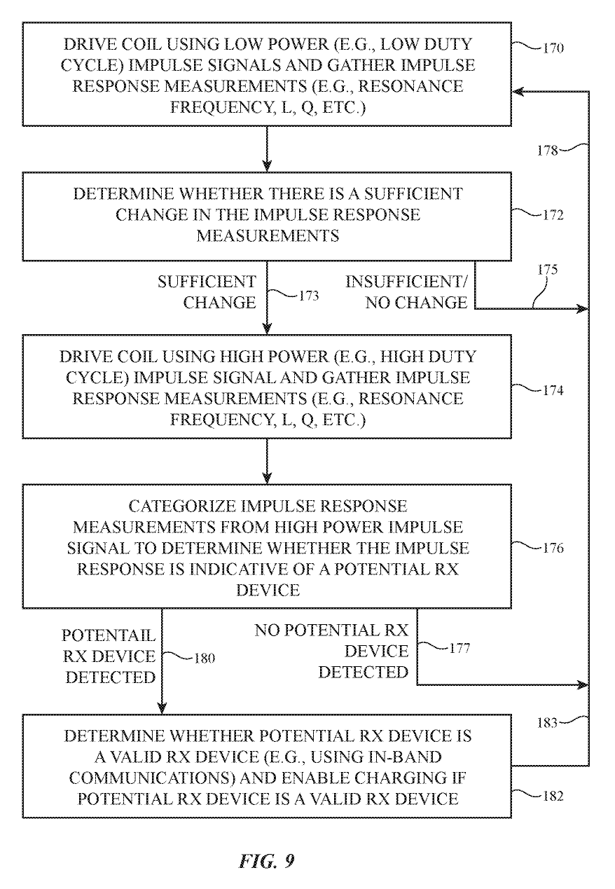

FIG. 9 is a flow chart of illustrative operations involved in providing low power impulse signals to coil 36 until a change in the environment over coil 36 is detected. The blocks of FIG. 9 may be performed by device 12 for one or more coils 36 (e.g., for each coil 36 or a subset of the coils 36 in sequence and/or in parallel).

During the operations of block 170, inverter 70 drives coil 36 using relatively low power impulse signals (e.g., two or more consecutive impulse signals). Coil 36 and capacitor 72 (FIG. 3) subsequently resonate in response to the low power impulse signals. Impulse response measurement circuitry 102 gathers impulse response measurements while coil 36 resonates. The impulse response measurements include measurements of frequency, inductance, Q factor, resistance of coil 36, and/or other measurements.

During the operations of block 172, impulse response measurement circuitry 102 and/or control circuitry 42 analyze the gathered impulse response measurements to determine whether there has been a sufficiently large change in the gathered impulse response measurements over time. For example, control circuitry 42 may identify changes in the impulse response measurements gathered in response to two or more of the impulse signals. The changes in impulse response measurements can include changes in inductance, Q factor, resonant frequency, resistance, and/or any other desired measurements from the impulse response of coil 36. In some configurations, control circuitry 42 may identify changes in averages or any other desired linear combination of impulse response measurements gathered in response to two or more of the impulse signals. Control circuitry 42 compares the identified changes to one or more threshold values and determines that there is a sufficient change if the identified changes exceed the threshold values. Control circuitry 42 determines that there is insufficient change if the identified changes do not exceed the threshold values. In some configurations, control circuitry 42 may determine that there is a sufficient change if there is any non-zero change in the gathered impulse response measurements over time and may determine that there is insufficient change if there is no change in the gathered impulse response measurements, if desired.

In response to determining that there is insufficient change or no change in the impulse response measurements, processing may loop back to block 170 as shown by paths 175 and 178. Control circuitry 42 continues to control inverter 70 to drive coil 36 using low power impulse signals. The low power impulse signals minimize or eliminate the risk of generating physical vibrations and audible noise in the event that a metal foreign object is placed over coil 36.

In response to determining that there is a sufficient change in the impulse response measurements, processing may proceed to block 174 as shown by path 173. During the operations of block 174, inverter 70 drives coil 36 using a relatively high power impulse signal. Coil 36 and capacitor 72 (FIG. 3) subsequently resonate in response to the high power impulse signal. Impulse response measurement circuitry 102 gathers impulse response measurements while coil 36 resonates. The impulse response measurements include measurements of frequency, inductance, Q factor, resistance of coil 36, and/or other measurements. The high power impulse signal allows impulse response measurement circuitry 102 and control circuitry 42 to make a more reliable characterization of the environment over coil 36. While the high power impulse signal carries some risk of generating audible noise (i.e., given the risk that a metal foreign object may be present over coil 36), control circuitry 42 temporarily sacrifices this risk in order to temporarily boost reliability and accuracy in the impulse response measurements.

During the operations of block 176, impulse response measurement circuitry 102 and/or control circuitry 42 analyze the gathered impulse response measurements to categorize (characterize) the environment over coil 36 (e.g., control circuitry 42 uses the gathered impulse response measurements to determine whether coil 14 of device 10 is over coil 36, whether a metal foreign object is over coil 36, whether a ferromagnetic material is over coil 36, whether any other material is over coil 36, etc.). Control circuitry 42 may categorize the environment over coil 36 with greater reliability and accuracy than in scenarios where only low power impulse signals are used, for example. If control circuitry 42 determines that no potential wireless power receiving device is located over coil 36 (e.g., that there is no inductive coil such as coil 14 of device 10 present over coil 36), processing loops back to block 170 as shown by paths 177 and 178. Control circuitry 170 then continues to drive coil 36 using low power impulse signals with minimal or no risk of generating physical vibrations and audible noise in the event that a metal object is placed over coil 36. If control circuitry 42 determines that a potential wireless power receiving device (e.g., an inductive coil such as coil 14 of device 10) is located over coil 36, processing proceeds to block 182 as shown by path 182.

During the operations of block 182, control circuitry 42 determines whether the potential wireless power receiving device is a valid wireless power receiving device such as device 10 of FIG. 1 (e.g., using data transmission and reception between coils 14 and 36 or using separate antennas as described above in connection with block 156 of FIG. 8). In response to determining that a valid wireless power receiving device is present on charging surface 60 over coil 36 (e.g., in response to determining that coil 14 of wireless power receiving device 10 is present on charging surface 60 over coil 36), control circuitry 42 enables wireless power transmission to wireless power receiving device 10. Rectifier 80 on device 10 converts the received alternating-current signals from coil 14 into direct-current (DC) power signals for powering circuitry in device 10 such as load 100 (FIG. 3). Processing subsequently loops back to block 170 as shown by paths 183 and 178. In this way, control circuitry 42 continues to periodically transmit low power impulse signals while also conveying wireless power to device 10. Control circuitry 42 continues to monitor the impulse response measurements for changes in the environment over coil 36 (e.g., changes indicative of device 10 being moved away from coil 36) while also transmitting wireless power to device 10 with minimal or no risk of generating physical vibrations or audible noise in device 10 or device 12. In response to determining that a valid wireless power receiving device is not present over coil 36 (while performing the operations of block 176), processing loops back to block 170 as shown by paths 183 and 178. Control circuitry 42 thereby continues to monitor the impulse response measurements for changes in the environment over coil 36 (e.g., changes indicative of an object such as a metal object or an inductive coil such as coil 14 of device 10 being moved over coil 36) with minimal or no risk of generating physical vibrations or audible noise in device 10 or device 12. In some configurations, device 12 uses dedicated coils 36 (E.g., coils 36 that do not transmit wireless power to device 10) to transmit impulse signals and to gather corresponding impulse response measurements, if desired.

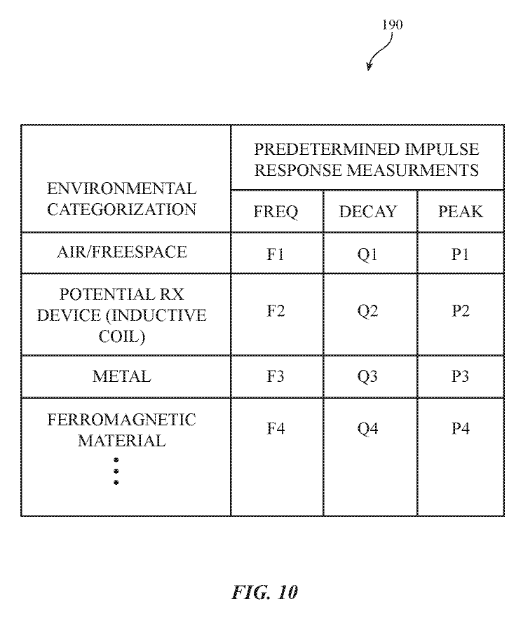

FIG. 10 shows an illustrative table 190 of predetermined impulse response measurements that may be processed by control circuitry 42. Control circuitry 42 uses the predetermined impulse response measurements of table 190 in categorizing the environment over coils 36 (e.g., while performing the operations of block 176 of FIG. 9 and block 142 if FIG. 8) and in determining whether a metal object is present on charging surface 60 over coil 36 (e.g., while performing the operations of block 122 of FIG. 7). Each row of predetermined impulse response measurements in table 190 form characteristic impulse response measurements that are expected for a corresponding environment over coil 36 (shown as “environmental categorizations” in the first column of table 190). The predetermined impulse response measurements may sometimes be referred to herein as characteristic impulse response measurements or expected impulse response measurements.

In the example of FIG. 10, control circuitry 42 and table 190 identifies a first categorization (e.g., an air or freespace categorization) in which no objects are present over coil 36, a second categorization (e.g., a potential RX device categorization) in which an inductive coil of a potential wireless power receiving device (e.g., inductive coil 14 of device 10 of FIG. 1) is present on charging surface 60 over coil 36, a third categorization (e.g., a metal categorization) in which a metal object is present over coil 36, and a fourth categorization (e.g., a ferromagnetic material categorization) in which a ferromagnetic material is present over coil 36. These examples are merely illustrative. If desired, table 190 may include any desired number of environmental categorizations (e.g., more than four or less than four categorizations), one or more of the categorizations shown in FIG. 10 may be omitted, etc.

As shown in FIG. 10, the predetermined impulse response measurements include frequency measurements, decay measurements (e.g., Q factor measurements), and peak magnitude measurements gathered from the impulse response of coil 36 generated by a corresponding impulse signal (e.g., measurements gathered from impulse response IR or IR′ of FIG. 4). This example is merely illustrative and, if desired, table 190 may include any desired types of impulse response measurements (e.g., fewer than three types of impulse response measurements, more than three types of impulse response measurements, etc.). In the example of FIG. 10, the air or freespace categorization includes a corresponding set of predetermined impulse response measurement values that includes an expected frequency F1, an expected Q factor Q1, and an expected peak magnitude P1. The potential RX device categorization includes a corresponding set of predetermined impulse response measurement values that includes an expected frequency F2, an expected Q factor Q2, and an expected peak magnitude P2. The metal categorization includes a corresponding set of predetermined impulse response measurement values that includes an expected frequency F3, an expected Q factor Q3, and an expected peak magnitude P3. The ferromagnetic material categorization includes a corresponding set of predetermined impulse response measurement values that includes an expected frequency F4, an expected Q factor Q4, and an expected peak magnitude P4. These predetermined impulse response measurement values are generated during calibration of device 12 (e.g., during manufacture, assembly, testing, and/or normal use of device 12 by identifying the impulse response of coils 36 using known materials or objects placed over coil 36). In practice, the values F1, F2, F3, and F4 may each different or two or more of values F1, F2, F3, and F4 may be the same. Similarly, the values Q1, Q2, Q3, and Q4 may each be different or two or more values Q1, Q2, Q3, and Q4 may be the same, and the values P1, P2, P3, and P4 may each be different or two or more values P1, P2, P3, and P4 may be the same. In one particular example, F2 is less than F1, F4 is greater than F1, F4 is approximately equal to F1, Q2 is greater than Q1, Q3 is approximately equal to Q1, Q4 is greater than both Q1 and Q2, P2 is less than P1, P3 is greater than P1, and P4 is approximately equal to P1. This example is merely illustrative. The predetermined impulse response measurements are stored on device 12 for subsequent processing by control circuitry 42.

Control circuitry 42 compares the gathered impulse response measurements (e.g., while processing the operations of block 122 of FIG. 7, block 176 of FIG. 9, and block 142 of FIG. 8) to the environmental categorizations of table 190. If the gathered impulse response measurements match the predetermined impulse response measurements of a given row of table 190 (e.g., if one, more than one, or all of the gathered impulse response measurements are within predetermined margins of the corresponding predetermined impulse response measurement values of a given row of table 190), control circuitry 42 may categorize the environment above coil 36 using the corresponding environmental categorization of that row of table 190. For example, if the gathered impulse response measurements match frequency F3, Q factor Q3, and/or peak value P3, control circuitry 42 may determine that a metal object is present on charging surface 60 over coil 36. Similarly, if the gathered impulse response measurements match frequency F3, Q factor Q3, and/or peak value P3, control circuitry 42 may determine that an inductive coil on a potential receiver device is present on charging surface 60 over coil 36.

The foregoing is illustrative and various modifications can be made to the described embodiments. The foregoing embodiments may be implemented individually or in any combination.

What is claimed is:

1. A wireless power transmitting device with a charging surface configured to receive a wireless power receiving device that has a wireless power receiving coil, the wireless power transmitting device comprising:
a coil;
wireless power transmitting circuitry coupled to the coil and configured to transmit wireless power signals with the coil;
impulse response measurement circuitry coupled to the coil; and
control circuitry configured to:
control the wireless power transmitting circuitry to supply a first impulse signal at a first maximum power level to the coil;
measure an impulse response of the coil with the impulse response measurement circuitry;
detect whether a metal foreign object is present on the charging surface based on the measured impulse response; and
control the wireless power transmitting circuitry to supply a second impulse signal at a second maximum power level to the coil in response to detecting that the metal foreign object is present on the charging surface, wherein the second maximum power level is different from the first maximum power level.

2. The wireless power transmitting device defined in claim 1, wherein the second maximum power level is less than the first maximum power level.

3. The wireless power transmitting device defined in claim 2, wherein the wireless power transmitting circuitry comprises an inverter, wherein the control circuitry is further configured to control the wireless power transmitting circuitry to supply the first impulse signal to the coil by providing a control signal to the inverter using a first duty cycle, and wherein the control circuitry is further configured to control the wireless power transmitting circuitry to supply the second impulse signal to the coil by providing the control signal to the inverter using a second duty cycle that is lower than the first duty cycle.

4. The wireless power transmitting device defined in claim 2, wherein the control circuitry is further configured to:
measure an additional impulse response of the coil using the impulse response measurement circuitry, wherein the additional impulse response is generated on the coil in response to the second impulse signal; and
determine whether the metal foreign object has moved away from the coil based on the additional impulse response.

5. The wireless power transmitting device defined in claim 1, wherein the control circuitry is further configured to:
control the wireless power transmitting circuitry to supply the second impulse signal to the coil at the first maximum power level in response to detecting that no metal foreign objects overlapping the coil are present on the charging surface.

6. The wireless power transmitting device defined in claim 1, wherein the control circuitry is further configured to:
detect whether an inductive coil is present on the charging surface based on the measured impulse response; and
control the wireless power transmitting circuitry to determine whether the inductive coil is associated with the wireless power receiving device in response to detecting that the inductive coil is present on the charging surface.

7. The wireless power transmitting device defined in claim 6, wherein the control circuitry is further configured to determine whether the inductive coil is associated with the wireless power receiving device by transmitting wireless data using the coil.

8. The wireless power transmitting device defined in claim 6, wherein the control circuitry is further configured to:
enable the coil to transmit the wireless power signals in response to determining that the inductive coil is associated with the wireless power receiving device.

9. The wireless power transmitting device defined in claim 8, wherein the control circuitry is further configured to:
control the wireless power transmitting circuitry to supply a third impulse signal to the coil at the first maximum power level after enabling the coil to transmit the wireless power signals.

10. The wireless power transmitting device defined in claim 8, wherein the control circuitry is further configured to:
control the wireless power transmitting circuitry to supply a third impulse signal to the coil at the first maximum power level in response to determining that the inductive coil is not associated with the wireless power receiving device.

11. The wireless power transmitting device defined in claim 1, wherein the measured impulse response comprises a measurement selected from the group consisting of: an inductance measurement of the coil in response to the first impulse signal, a frequency measurement of the coil in response to the first impulse signal, and a Q factor measurement of the coil in response to the first impulse signal.

12. A wireless power transmitting device with a charging surface configured to receive a wireless power receiving device that has a wireless power receiving coil, the wireless power transmitting device comprising:
a coil;
wireless power transmitting circuitry coupled to the coil and configured to transmit wireless power signals with the coil;
impulse response measurement circuitry coupled to the coil; and
control circuitry configured to:
control the wireless power transmitting circuitry to supply impulse signals at a first maximum power level to the coil, wherein the impulse signals generate impulse responses on the coil;
gather measurements of the impulse responses on the coil with the impulse response measurement circuitry;
determine whether the gathered measurements have changed over time; and
control the wireless power transmitting circuitry to supply an additional impulse signal at a second maximum power level to the coil in response to determining that the gathered measurements have changed over time, wherein the second maximum power level is greater than the first maximum power level.

13. The wireless power transmitting device defined in claim 12, wherein the additional impulse signal generates an additional impulse response on the coil, and wherein the control circuitry is further configured to:
gather an additional measurement of the additional impulse response on the coil; and
characterize an environment on the charging surface based on the gathered additional measurement.

14. The wireless power transmitting device defined in claim 13, wherein the control circuitry is further configured to:
detect whether an inductive coil is present on the charging surface based on the gathered additional measurement; and
control the wireless power transmitting circuitry to determine whether the inductive coil is associated with the wireless power receiving device in response to detecting that the inductive coil is present on the charging surface.

15. The wireless power transmitting device defined in claim 14, wherein the control circuitry is further configured to determine whether the inductive coil is associated with the wireless power receiving device by transmitting wireless data using the coil.

16. The wireless power transmitting device defined in claim 14, wherein the control circuitry is further configured to:
enable the coil to transmit the wireless power signals in response to determining that the inductive coil is associated with the wireless power receiving device; and
control the wireless power transmitting circuitry to supply an additional set of impulse signals to the coil at the first maximum power level after enabling the coil to transmit the wireless power signals.

17. The wireless power transmitting device defined in claim 12, wherein the coil comprises one of a plurality of coils arranged in an array adjacent to the charging surface.

18. The wireless power transmitting device defined in claim 12, wherein the gathered measurements comprise a measurement selected from the group consisting of: an inductance measurement, a frequency measurement, and a Q factor measurement.

19. A wireless power transmitting device configured to transmit wireless power signals to a wireless power receiving device, the wireless power transmitting device comprising:
a coil;
inverter circuitry coupled to the coil and configured to transmit the wireless power signals with the coil;
impulse response measurement circuitry coupled to the coil; and
control circuitry configured to:
provide a first control signal to the inverter circuitry using a first duty cycle, wherein the first control signal controls the inverter circuitry to supply a first impulse signal to the coil;
measure a response of the coil to the first impulse signal with the impulse response measurement circuitry; and
provide a second control signal to the inverter circuitry using a second duty cycle that is different than the first duty cycle based on the measured response of the coil to the first impulse signal, wherein the second control signal controls the inverter circuitry to supply a second impulse signal to the coil.

20. The wireless power transmitting device defined in claim 19, wherein the second duty cycle is less than the first duty cycle, and wherein the control circuitry is further configured to:
detect a presence of a metal foreign object on the coil based on the measured response of the coil; and
provide the second control signal to the inverter circuitry in response to detecting the presence of the metal foreign object on the coil.
